(19) United States
(12) Patent Application Publication
(10) Pub. No.: US 2025/0300382 A1
(43) Pub. Date: Sep. 25, 2025

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Yasunori ASANO, Mie (JP)

(21) Appl. No.: 18/869,283

(22) PCT Filed: May 8, 2023
(86) PCT No.: PCT/JP2023/017261

§ 371 Date: Nov. 26, 2024

(30) Foreign Application Priority Data
May 27, 2022 (JP) 2022-086610

(51) Int. Cl. H01R 13/15; H01R 24/38

(52) U.S. Cl. CPC H01R 13/15; H01R 24/38

(57) ABSTRACT

A connector includes a terminal module including an inner conductor, an insulator surrounding the inner conductor and an outer conductor having a tube portion surrounding the insulator and a projecting portion projecting outwardly of the tube portion, and a mating connection conductor. At least one of the mating connection conductor and the projecting portion includes a spring connecting portion to be resiliently pressed against the other of the mating connection conductor and the projecting portion with a contact pressure having a force component along an axial direction of the tube portion.

### TECHNICAL FIELD

The present disclosure relates to a connector.

### BACKGROUND

Patent Document 1 disclose a connector module provided with a terminal module including an electrically conductive shell and a shield case. A bottom part of the shield case includes a hollow cylindrical projecting portion, and the terminal module is joined to the shield case with the outer peripheral surface of the electrically conductive shell of the terminal module and the inner peripheral surface of the projecting portion held in surface contact.

### PRIOR ART DOCUMENT

### Patent Document

Patent Document 1: JP 2018-006162 A

### SUMMARY OF THE INVENTION

### Problems to be Solved

According to a technique disclosed in Patent Document 1, the connector module may be enlarged since the projecting portion projects from the bottom part of the shield case.

Accordingly, the present disclosure aims to enable an outer conductor of a connector to be connected to a mating connection conductor by a compact configuration.

### Means to Solve the Problem

The present disclosure is directed to a connector with a terminal module including an inner conductor, an insulator surrounding the inner conductor and an outer conductor having a tube portion surrounding the insulator and a projecting portion projecting outwardly of the tube portion, and a mating connection conductor, at least one of the mating connection conductor and the projecting portion including a spring connecting portion to be resiliently pressed against the other of the mating connection conductor and the projecting portion with a contact pressure having a force component along an axial direction of the tube portion.

### Effect of the Invention

According to the present disclosure, an outer conductor of a connector can be connected to a mating connection conductor by a compact configuration.

### BRIEF DESCRIPTION OF THE DRAWINGS

FIG. 1 is a perspective view showing a device provided with a connector according to an embodiment.

FIG. 2 is a section along II-II of FIG. 1.

FIG. 3 is a perspective view showing a second case and the connector when viewed from inside.

FIG. 4 is a perspective view showing the connector when viewed from outside.

FIG. 5 is an exploded perspective view of the connector.

FIG. 6 is an enlarged section of a circled part A of FIG. 2.

FIG. 7 is a section showing a connector according to a modification.

### DETAILED DESCRIPTION TO EXECUTE THE INVENTION

### Description of Embodiments of Present Disclosure

First, embodiments of the present disclosure are listed and described.

A connector of the present disclosure is as follows.

(1) The connector of the present disclosure is provided with a terminal module including an inner conductor, an insulator surrounding the inner conductor and an outer conductor having a tube portion surrounding the insulator and a projecting portion projecting outwardly of the tube portion, and a mating connection conductor, at least one of the mating connection conductor and the projecting portion including a spring connecting portion to be resiliently pressed against the other of the mating connection conductor and the projecting portion with a contact pressure having a force component along an axial direction of the tube portion.

According to this connector, the spring connecting portion is resiliently pressed against the projecting portion or the mating connection conductor with the contact pressure having the force component along the axial direction of the tube portion. Thus, the size of the spring connecting portion can be reduced in a direction along the axial direction of the tube portion as compared to a configuration for generating a contact pressure in a direction perpendicular to the axial direction of the tube portion. In this way, the outer conductor of the connector can be connected to the mating connection conductor by a compact configuration. Further, since the mating connection conductor and the outer conductor are electrically connected via the spring connecting portion, connection reliability is improved.

(2) In the connector of (1), the mating connection conductor may be a shield conductor. In this case, a projecting dimension of the outer conductor from the shield conductor can be reduced.

(3) In the connector of (1) or (2), the mating connection conductor may include the spring connecting portion. In this case, the projecting portion of the outer conductor may not be provided with the spring connecting portion. In this way, limitations in manufacturing the outer conductor are reduced and the outer conductor can be easily manufactured.

(4) In the connector of any one of (1) to (3), the spring connecting portion may include a spring fulcrum and a spring contact point, and the projecting portion and the mating connection conductor may be fixed at a position closer to the spring fulcrum than to the spring contact point.

In this way, the projecting portion and the mating connection conductor can be kept in a fixed positional relationship at the position closer to the spring fulcrum than to the spring contact point. In this way, the contact pressure by the spring connecting portion is easily ensured.

(5) In the connector of (4), the projecting portion and the mating connection conductor may be fixed to each other by being pressed while being overlapped with each other. In this way, the projecting portion and the mating connection conductor can be easily fixed.

(6) The connector of any one of (1) to (5) may include a plurality of the spring connecting portions. In this way, the connection reliability of the outer conductor and the mating connection conductor can be improved.

(7) In the connector of (6), the plurality of spring connecting portions may be distributed around the tube portion. In this way, a contact state of the outer conductor and the mating connection conductor via the spring connecting portions of either one of the outer conductor and the mating connection conductor is easily maintained, for example, even if the tube portion is inclined. In this way, the connection reliability of the outer conductor and the mating connection conductor can be improved.

(8) In the connector of (7), the plurality of spring connecting portions may be distributed at equal intervals around the tube portion. In this way, the respective spring connecting portions easily contact the projecting portion or the mating connection conductor in a uniform state.

(9) In the connector of any one of (6) to (9), the projecting portion and the mating connection conductor may be fixed at a plurality of positions. In this way, since the projecting portion and the mating connection conductor are kept in a fixed positional relationship at the plurality of positions, the plurality of spring connecting portions are easily held in contact with the projecting portion or the mating connection conductor.

(10) In the connector of (9), the projecting portion and the mating connection conductor may be fixed at the plurality of positions distributed around the tube portion. In this case, the projecting portion and the mating connection conductor are kept in the fixed positional relationship at the plurality of positions distributed around the tube portion. In this way, the plurality of spring connecting portions are easily held in contact with the projecting portion or the mating connection conductor.

(11) In the connector of (10), the projecting portion and the mating connection conductor may be fixed at the plurality of positions uniformly distributed around the tube portion. In this case, the projecting portion and the mating connection conductor are kept in the fixed positional relationship at the plurality of positions uniformly distributed around the tube portion. In this way, the plurality of spring connecting portions are easily held in contact with the projecting portion or the mating connection conductor.

(12) In the connector of any one of (9) to (11), the plurality of spring connecting portions and the plurality of fixing positions of the projecting portion and the mating connection conductor may have the same positional relationship and be in a one-to-one correspondence. In this way, contact pressures by the respective spring connecting portions are easily made equal and connection reliability is improved.

### Details of Embodiment of Present Disclosure

A specific example of a connector of the present disclosure is described below with reference to the drawings. Note that the present disclosure is not limited to these illustrations, but is represented by claims and intended to include all changes in the scope of claims and in the meaning and scope of equivalents.

### Embodiment

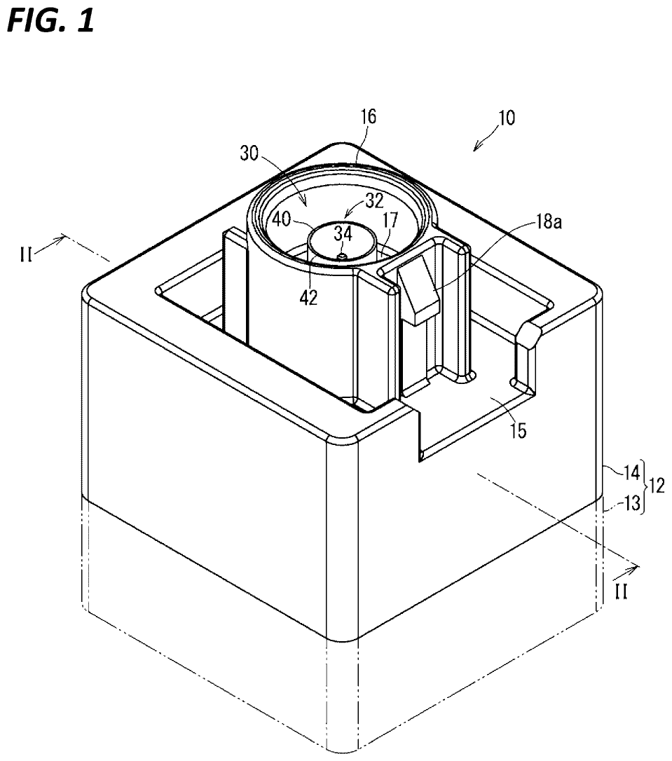

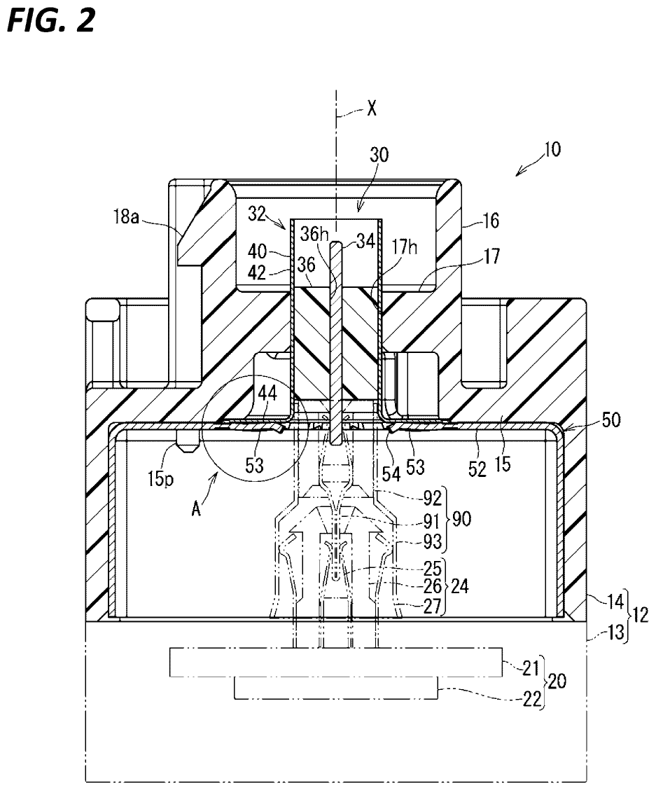

Hereinafter, a connector according to an embodiment is described. FIG. 1 is a perspective view showing a device 10 provided with a connector 30. FIG. 2 is a section along II-II of FIG. 1.

### <Concerning Overall Configuration of Device>

The device 10 is, for example, a camera device. The camera device is, for example, an in-vehicle device. The device 10 may not be the camera device.

The device 10 is provided with a case 12, an electrical component 20 and a connector 30. The electrical component 20 is accommodated in the case 12. The connector 30 is a connector for connecting the electrical component 20 and an external electrical component. For example, the connector 30 is a connector, to which a cable connected to the external electrical component is connected.

The case 12 is provided with a first case 13 and a second case 14. The first and second cases 13, 14 are, for example, made of resin. By uniting the first and second cases 13, 14, the case 12 in the form of a rectangular parallelepiped box for accommodating the electrical component 20 is configured. If the device 10 is a camera device, it is assumed that the first case 13 includes a lens or window for imaging and the second case 14 includes the connector 30.

The electrical component 20 is, for example, a mounting board in which electronic components are mounted on a board. If the device 10 is a camera device, the electrical component 20 is assumed to include a circuit board 21 and an imaging element 22 mounted on the circuit board 21. The imaging element 22 faces the lens or window for imaging of the first case 13 and images an outside view by turning the lens or window. The side of the first case 13, toward which the imaging element 22 is facing, may be referred to as a front side and the side of the second case 14 opposite to the front side may be referred to as a rear side below.

In this embodiment, the electrical component 20 is provided with a board-side connector 24 located on a surface of the circuit board 21 on a side opposite to the imaging element 22. The board-side connector 24 is, for example, provided with a board-side inner conductor 25, a board-side insulator 26 and a board-side outer conductor 27. The board-side insulator 26 surrounds the board-side inner conductor 25. A dielectric can be understood as one type of the insulator, and the board-side insulator 26 may be a dielectric. The board-side outer conductor 27 surrounds the board-side insulator 26. The board-side connector 24 projects toward the connector 30 from the circuit board 21.

A relay connector 90 is connected to the board-side connector 24. The relay connector 90 is, for example, provided with a movable-side inner conductor 91, a movable-side insulator 92 and a movable-side outer conductor 93. The movable-side insulator 92 surrounds the movable-side inner conductor 91. A dielectric can be understood as one type of the insulator, and the movable-side insulator 92 may be a dielectric. The movable-side outer conductor 93 surrounds the movable-side insulator 92. With the movable-side inner conductor 91 inserted and connected to the board-side inner conductor 25 and the board-side outer conductor 27 inserted and connected to the movable-side outer conductor 93, the relay connector 90 is connected to the board-side connector 24. The relay connector 90 projects further toward the connector 30 from the board-side connector 24. The relay connector 90 relays and connects the board-side connector 24 and the connector 30. The relay connector 90 is connected to the board-side connector 24 and the connector 30 in a posture changeable state.

The connector 30 is provided on the side of the second case 14, i.e. on a rear side of the case 12. The relay connector 90 is connected to the connector 30 in the case 12. By connecting a cable from outside to the connector 30, an external electrical component as a connection destination of this cable and the electrical component 20 in the case 12 are electrically connected.

### <Connector>

The connector 30 is more specifically described.

### <Overall Configuration of Connector>

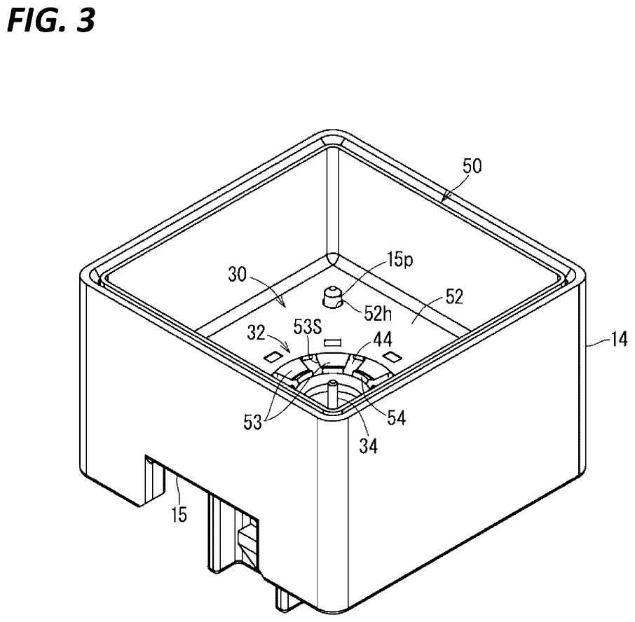

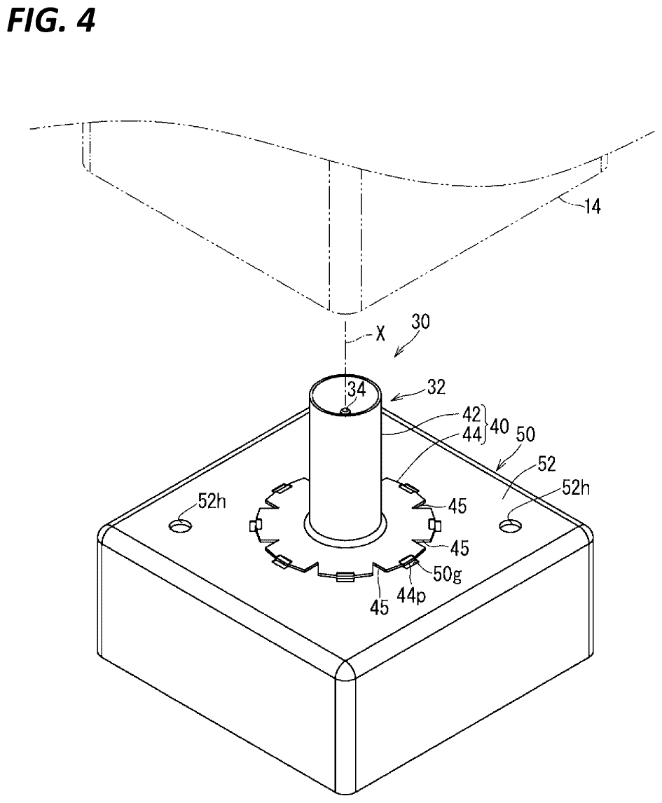

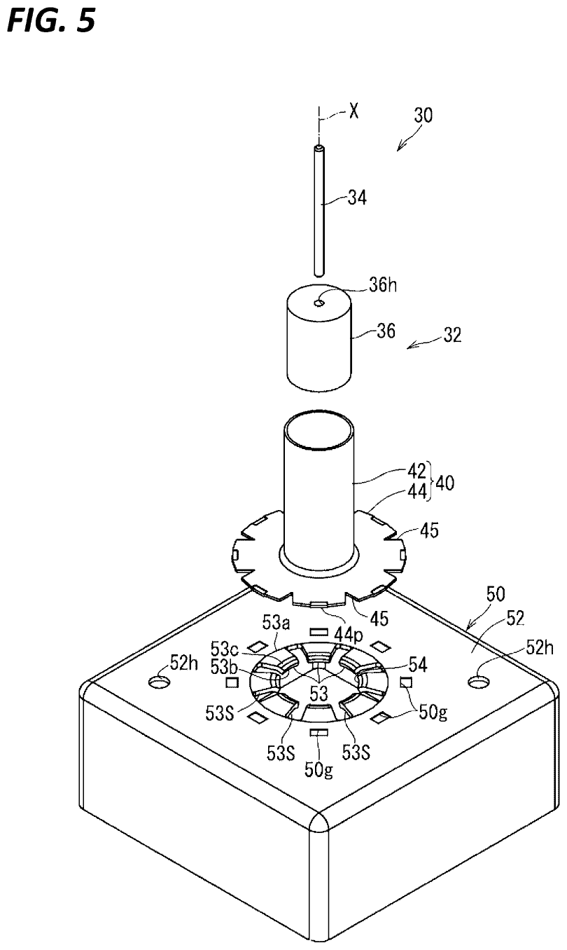

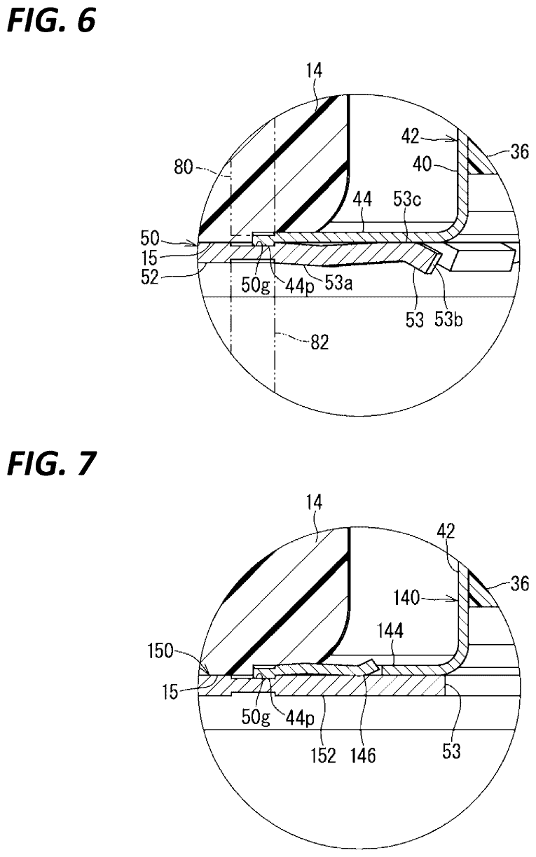

FIG. 3 is a perspective view showing the second case 14 and the connector 30 when viewed from inside. FIG. 4 is a perspective view showing the connector 30 when viewed from outside. FIG. 5 is an exploded perspective view of the connector 30. FIG. 6 is an enlarged section of a circled part A of FIG. 2.

As shown in FIGS. 2 to 6, the connector 30 is provided with a terminal module 32 and a mating connection conductor 50.

The terminal module 32 includes an inner conductor 34, an insulator 36 and an outer conductor 40. The insulator 36 surrounds the inner conductor 34. A dielectric can be understood as one type of the insulator, and the insulator 36 may be a dielectric. The outer conductor 40 surrounds the insulator 36.

The mating connection conductor 50 is a conductor as an electrical connection destination of the outer conductor 40, and made of metal. In this embodiment, the mating connection conductor 50 is a shield conductor for electromagnetically shielding the electrical component 20 and outside. More specifically, the mating connection conductor 50 is in the form of a rectangular parallelepiped box open on one side, and arranged along the inner side surface of the second case 14. The mating connection conductor 50 can electromagnetically shield the electrical component 20 and outside behind the electrical component 20 by being located behind the electrical component 20. The board-side connector 24 and the relay connector 90 can be electromagnetically shielded from a side around the board-side connector 24 and the relay connector 90 and outside behind the board-side connector 24 and the relay connector 90 by the mating connection conductor 50 surrounding the board-side connector 24 and the relay connector 90 and being located behind the board-side connector 24 and the relay connector 90.

It is not essential that the mating connection conductor 50 has the above shape. A mating connection conductor may be, for example, in the form of a plate extending along the inner surface of a bottom portion of the second case 14. A mating connection conductor may extend toward the first case 13. A mating connection conductor may be electrically connected to the shield connector on the side of the first case 13.

The terminal module 32 is supported on a bottom portion 15 of the second case 14. The mating connection conductor 50 is also supported in the second case 14. The configuration of the second case 14 for supporting the terminal module 32 and the mating connection conductor 50 is described.

A bottom portion 52 of the mating connection conductor 50 is formed into a shape expanding over the entire inner surface of the bottom portion 15 of the second case 14, here into a rectangular shape. Holes 52h are formed in the bottom portion 52. Fixing protrusions 15p fittable into the holes 52h are provided to project on the inner surface of the bottom portion 15 of the second case 14. By fitting the fixing protrusions 15p into the holes 52h, the mating connection conductor 50 is supported in the second case 14. For example, the fixing protrusions 15p may be press-fit into the holes 52h. For example, with the fixing protrusions 15p inserted in the holes 52h, tip parts of the fixing protrusions 15p may be melted by heating or the like and melted and solidified parts may be retained and hooked to the peripheral edges of the holes 52h. For example, retaining protrusions may be formed on the tip parts of the fixing protrusions 15p, and the retaining protrusions may come out from the holes 52h and the fixing protrusions 15p may be inserted into the holes 52h, utilizing the resilient deformation of peripheral edge parts of the fixing protrusions 15p or the holes 52h. In this case, after the fixing protrusions 15p are inserted into the holes 52h, the peripheral edge parts of the fixing protrusions 15p or the holes 52h return to an initial shape and the retaining protrusions are hooked to the peripheral edge parts of the holes 52h.

A configuration for fixing the mating connection conductor to the second case 14 is not limited to the above example. For example, the mating connection conductor may be fixed to the second case 14 by screwing, an adhesive or the like.

A holding tube portion 16 is provided to project on the bottom portion 15. The holding tube portion 16 is a hollow cylinder and projects outward from a central part of the bottom portion 15. An inner opening of the holding tube portion 16 is open in the second case 14, and an outer opening of the holding tube portion 16 is open to the outside of the second case 14. A holding/partitioning portion 17 is formed in an axially intermediate part of the holding tube portion 16. The holding/partitioning portion 17 partitions between a space on the inner opening side and a space on the outer opening side in the holding tube portion 16. The holding/partitioning portion 17 is formed with a holding hole 17h, and the terminal module 32 is inserted and held in this holding hole 17h.

In this embodiment, a locking protrusion 18a for holding a cable connector mounted on an end part of the cable is formed on an outer peripheral part of the holding tube portion 16. It is not essential that the locking protrusion 18a is formed.

### <Terminal Module>

The terminal module 32 is more specifically described. As described above, the terminal module 32 is provided with the inner conductor 34, the insulator 36 and the outer conductor 40.

The inner conductor 34 is in the form of an elongated bar and made of an electrically conductive material such as metal.

The insulator 36 is made of an insulating material such as resin and surrounds the inner conductor 34. In this embodiment, the insulator 36 is a dielectric. The insulator 36 is formed into a cylindrical shape. A length of the insulator 36 is shorter than that of the inner conductor 34. A through hole 36h is formed along an extension direction of the insulator 36 in a center of the insulator 36. The inner conductor 34 is inserted into the through hole 36h, and a longitudinally intermediate part of the inner conductor 34 is held in the through hole 36h. With the inner conductor 34 held in the insulator 36, both end parts of the inner conductor 34 project outward from both end surfaces of the insulator 36. The inner conductor 34 may be formed with a locking projection to be hooked to the inner peripheral surface of the through hole 36h.

The outer conductor 40 includes a tube portion 42 and a projecting portion 44 and is made of an electrically conductive material such as metal. The tube portion 42 is formed into a tubular shape surrounding the insulator 36. More specifically, the tube portion 42 is formed into a hollow cylindrical shape. A length of the tube portion 42 is larger than that of the insulator 36. The insulator 36 is held in a longitudinally intermediate part of the tube portion 42, and both ends of the tube portion 42 project outward from the both ends of the insulator 36. The tube portion 42 may be formed with a locking projection to be hooked to any one of the outer peripheral surface and the respective end surfaces of the insulator 36.

The projecting portion 44 projects outwardly of the tube portion 42. More specifically, the projecting portion 44 is formed into a disk shape projecting outwardly of the tube portion 42 along a direction orthogonal to an axial direction of the tube portion 42 from one side end edge of the tube portion 42. Recesses 45 extending toward an inner peripheral side from the outer peripheral edge of the projecting portion 44 are formed. The recess 45 is a V-shaped recess gradually narrowed toward the inner peripheral side from the outer peripheral edge of the projecting portion 44. The projecting portion 44 is formed with a plurality of the recesses 45. The plurality of recesses 45 are formed at equal intervals along a circumferential direction of the projecting portion 44. In this embodiment, eight recesses 45 are formed at intervals of 45° around a center axis X of the tube portion 42. It is not essential that the above recesses 45 are formed.

The outer conductor 40 may be formed by deep drawing of a metal material. If the outer conductor 40 is formed by deep drawing, the outer conductor having the formation of joints and slits suppressed can be manufactured at a low cost. In this case, the recesses 45 can function to suppress an outer peripheral part of the projecting portion 44 from becoming excessively thin by being stretched. The outer conductor may be formed by press-working a metal plate, may be formed by molding or may be formed by cutting.

The tube portion 42 is inserted into the holding hole 17h of the holding/partitioning portion 17 from the inside of the second case 14, and a longitudinally intermediate part of the tube portion 42 is held by the holding hole 17h. The tube portion 42 may be held by a frictional holding force between the outer peripheral surface of the tube portion 42 and the inner peripheral surface of the holding hole 17h. The tube portion 42 may be formed with a projection to be hooked to an inner peripheral part of the holding hole 17h. The tube portion 42 may be fixed to the holding hole 17h by an adhesive, screwing or the like.

With the tube portion 42 held by the holding/partitioning portion 17, one end of the tube portion 42 projects further inward than the partitioning/holding portion 17 and is arranged to face an outward facing part of the bottom portion 52 of the mating connection conductor 50. The outer peripheral edge of the projecting portion 44 is expanded to be larger than the inner opening of the holding tube portion 16, and is in contact with an inner opening edge of the holding tube portion 16 on an inner facing surface of the bottom portion 15 of the second case 14.

The movable-side outer conductor 93 of the relay connector 90 is inserted and connected to the inner opening of the tube portion 42 and an inner end part of the inner conductor 34 is inserted and connected to the movable-side inner conductor 91, whereby the relay connector 90 and the connector 30 are connected in the case 12.

### <Concerning Electrical Connection Structure of Outer Conductor and Mating Connection Conductor>

One of the mating connection conductor 50 and the projecting portion 44 includes spring connecting portions 53 to be resiliently pressed against the other of the mating connection conductor 50 and the projecting portion 44 with contact pressures each having a force component along an axial direction of the tube portion 42. In this embodiment, an example is described in which the mating connection conductor 50 includes the spring connecting portions 53 to be resiliently pressed against the projecting portion 44 with contact pressures each having a force component along the axial direction of the tube portion 42.

That is, the bottom portion 52 of the mating connection conductor 50 is formed with an opening 54. The opening 54 is formed at a position facing the inner opening of the tube portion 42. The opening 54 has the same size as or larger than the inner opening of the tube portion 42 and smaller than the projecting portion 44. A center of the opening 54 is located on a center axis of the outer conductor 40. The projecting portion 44 is arranged to face an outward facing part of the bottom portion 52 around the opening 54.

The spring connecting portions 53 are formed in a part of the bottom portion 52 facing the projecting portion 44. In this embodiment, slits 53S are formed to extend outward from an edge part of the opening 54 in the bottom portion 52. The slit 53S extends along a radial direction of the opening 54. An end of the slit 53S on an outer peripheral side is located inward of the outer edge of the projecting portion 44. The spring connecting portion 53 is formed between two slits 53S.

An outer peripheral side end of the spring connecting portion 53 distant from the opening 54 is a spring fulcrum 53a integrally connected to the bottom portion 52. An inner peripheral side end of the spring connecting portion 53 near the opening 54 is a free end 53b configured to displace in a thickness direction of the bottom portion 52 with the spring fulcrum 53a as a fulcrum. A longitudinally intermediate part of the spring connecting portion 53 is bent to project toward the projecting portion 44, and a part of the spring connecting portion 53 projecting most toward the projecting portion 44 is a spring contact point 53c. In this embodiment, the spring contact point 53c is located closer to the free end 53b than to the spring fulcrum 53a.

In this embodiment, the slit 53S is a slit having a constant width and extending along the radial direction of the circular opening 54. Thus, the spring connecting portion 53 is formed into a trapezoidal shape wide on the side of the spring fulcrum 53a and narrow on the side of the free end 53b. A slit may be formed into a shape gradually widened from the opening toward an outer peripheral side, and a spring connecting portion may be formed into a nearly rectangular shape.

The connector 30 may be provided with at least one spring connecting portion 53. In this embodiment, the connector 30 is provided with a plurality of the spring connecting portions 53. Here, the plurality of spring connecting portions 53 are distributed around the tube portion 42. More specifically, the plurality of spring connecting portions 53 are distributed at equal intervals around the tube portion 42. Note that the meaning of equal is within a manufacturing error range (e.g. intervals differ within a range of ±5° around the center axis X of the tube portion 42). Preferably, three or more spring connecting portions 53 are distributed at equal intervals around the tube portion 42.

In this embodiment, eight slits 53S are formed around the opening 54 in the bottom portion 52. The eight slits 53S are formed at equal intervals around the center axis X of the tube portion 42. Thus, the eight spring connecting portions 53 having the same shape are formed at equal intervals around the opening 54.

In this embodiment, the plurality of spring connecting portions 53 and the plurality of recesses 45 are formed at the same positions around the center axis X of the tube portion 42. Thus, the respective spring connecting portions 53 are arranged to face parts of the projecting portions 44 between the recesses 45.

With the mating connection conductor 50 fixed to the second case 14, the tube portion 42 of the outer conductor 40 is inserted into the holding hole 17h of the holding tube portion 16 and held at a fixed position. Further, the outer peripheral edge of the projecting portion 44 is sandwiched between a part of the inward facing surface of the bottom portion 15 of the second case 14 around the inner opening of the holding tube portion 16 and a part of the outward facing surface of the bottom portion 52 of the mating connection conductor 50 around the opening 54. Thus, the projecting portion 44 of the outer conductor 40 is held at a fixed position with respect to the mating connection conductor 50.

Thus, the spring connecting portion 53 is held pressed against the projecting portion 44 along the radial direction of the tube portion 42. At this time, since the spring connecting portion 53 extends along a direction intersecting (here, substantially orthogonal to) the axial direction of the tube portion 42 from the spring fulcrum 53a, the spring connecting portion 53 is resiliently deformed to swing the spring contact point 53c around the spring contact point 53c. A contact pressure is generated between the spring contact point 53c and the projecting portion 44 by a resilient restoring force of the spring connecting portion 53 returning to an initial shape. At this time, the spring contact point 53c is displaced to swing around the spring contact point 53c and mainly displaced in the axial direction of the tube portion 42. Thus, a contact pressure between the spring contact point 53c and the projecting portion 44 has a force component along the axial direction of the tube portion 42 and the spring contact point 53c is pressed against the projecting portion 44 by the force component.

That is, the spring connecting portion 53 is a part designed to press the spring contact point 53c against the projecting portion 44 with a force including a force component along the axial direction of the tube portion 42. Thus, the spring connecting portion 53 is a spring along a direction intersecting the axial direction of the tube portion 42. To reduce the size of the tube portion 42 in the axial direction, the spring connecting portion 53 is preferably a spring intersecting the axial direction at an angle to be closer to the axial direction of the tube portion 42 than to a direction orthogonal to the axial direction, more preferably a spring along the direction orthogonal to the axial direction of the tube portion 42.

As described above, by pressing the spring connecting portions 53 against the projecting portion 44, a state where the outer conductor 40 and the mating connection conductor 50 contact and are satisfactorily electrically connected is maintained.

Note that both the holding of the holding tube portion 16 and the sandwiching of the outer peripheral edge of the projecting portion 44 are not essential. Further, such as when a fixing structure by press-working to be described later is realized, both the holding of the holding tube portion 16 and the sandwiching of the outer peripheral edge of the projecting portion 44 may be eliminated.

The projecting portion 44 and the mating connection conductor 50 may be fixed to each other. In this embodiment, the projecting portion 44 and the mating connection conductor 50 are fixed to each other by being pressed while being overlapped with each other. More specifically, the projecting portion 44 and the mating connection conductor 50 are pressed while being overlapped with each other, whereby fit-in protrusions 44p formed on the other of the projecting portion 44 and the mating connection conductor 50 are fit into fit-in recesses 50g formed in one of the projecting portion 44 and the mating connection conductor 50 to fix the projecting portion 44 and the mating connection conductor 50 to each other in an overlapping state. The fit-in recesses 50g may be formed before press-working in the overlapping state or may be formed during press-working. The fit-in protrusions 44p may be formed before press-working in the overlapping state. In either case, the fit-in protrusions 44p are fit into the fit-in recesses 50g by press-working in the overlapping state, and it may be made difficult for the fit-in protrusions 44p to come out from the fit-in recesses 50g due to the deformation of the fit-in protrusions 44p into a shape to hardly come out from the fit-in recesses 50g or the action of friction forces for preventing the fit-in protrusions 44p from coming out from the fit-in recesses 50g. As described above, the concave-convex fitting/fixing structure utilizing the plastic deformation of metal may be a fixing structure by a joining method called caulking joint or may be a fixing structure by a joining method called clinch caulking.

In this embodiment, the fit-in recesses 50g are formed in a part of the bottom portion 52 of the mating connection conductor 50 facing the projecting portion 44. The fit-in recesses 50g are formed at positions overlapping the outer peripheral edge of the projecting portion 44. Here, the fit-in recess 50g is a rectangular recess, but may be a circular, elliptical or polygonal recess. The fit-in recess 50g may be a hole penetrating through the bottom portion 52. Recesses are formed also in the inward facing part of the bottom portion 52, but this is not essential.

The projecting portion 44 is formed with the fit-in protrusions 44p. The fit-in protrusions 44p project toward the bottom portion 52 from the outer peripheral edge of the projecting portion 44. In this embodiment, the fit-in recesses 50g are formed at positions facing the outer peripheral edge of the projecting portion 44 and between the recesses 45. The fit-in protrusions 44p are formed at positions between the recesses 45 on the outer peripheral edge of the projecting portion 44 to correspond to the positions of the fit-in recesses 50g.

For example, the fit-in recesses 50g are formed in the bottom portion 52 of the mating connection conductor 50 in advance by press-working or the like, and the projecting portion 44 is overlapped on the bottom portion 52. In this state, a part of the outer peripheral edge of the projecting portion 44 facing the fit-in recesses 50g is caused to project toward the fit-in recesses 50g by a press mold 80 (see FIG. 6). In this way, the outer peripheral edge of the projecting portion 44 is plastically deformed to partially project and the fit-in protrusions 44p formed by this plastic deformation are fit into the fit-in recesses 50g. Note that a mold 82 for receiving a force may be arranged on a side opposite to the press mold 80.

The fit-in protrusions 44p are, for example, press-fit into the fit-in recesses 50g in a direction along the outer peripheral edge of the projecting portion 44 and hardly come out from the fit-in recesses 50g. By strongly pressing the plurality of fit-in protrusions 44p distributed around the tube portion 42 against side surfaces of the respective fit-in recesses 50g on the side of the tube portion 42, the fit-in protrusions 44p may be made difficult to come out from the fit-in recesses 50g.

Unlike the above, fit-in recesses and fit-in protrusions may be simultaneously press-worked by causing a press mold to simultaneously plastically deform a bottom portion and a projecting portion with the projecting portion overlapped on the bottom portion of a mating connection conductor. Further, a projecting portion may be formed with fit-in recesses and a bottom portion of a mating connection conductor may be formed with fit-in protrusions to be fit into the fit-in recesses.

As described above, by fitting the fit-in protrusions 44p into the fit-in recesses 50g, the projecting portion 44 and the mating connection conductor 50 are fixed at positions closer to the spring fulcrums 53a than to the spring contact points 53c. Thus, the spring fulcrums 53a of the spring connecting portions 53 can be more reliably held at the fixed positions and contact pressures by resilient forces of the spring connecting portions 53 can be effectively applied.

It is not essential that the projecting portion 44 and the mating connection conductor 50 are directly fixed. If the projecting portion 44 and the mating connection conductor 50 are fixed as described above, these may be fixed at one fixing position or at a plurality of fixing positions. If the projecting portion 44 and the mating connection conductor 50 are fixed at a plurality of positions, a positional relationship of the projecting portion 44 and the mating connection conductor 50 is stabilized and a contact state of the spring contact points 53c of the spring connecting portions 53 and the projecting portion 44 is stabilized. If the projecting portion 44 and the mating connection conductor 50 are fixed at a plurality of positions distributed around the tube portion 42, the contact state is more stable. If the projecting portion 44 and the mating connection conductor 50 are fixed at a plurality of positions uniformly distributed around the tube portion 42, the contact state is even more stable.

Further, the plurality of spring connecting portions 53 and the plurality of fixing positions have the same positional relationship and are in a one-to-one correspondence, and parts for holding the respective spring connecting portions 53 at the fixed positions with respect to the projecting portion 44 can be similarly aligned.

In this embodiment, the fit-in protrusions 44p are respectively formed at center positions between the plurality of recesses 45 on the outer peripheral edge of the projecting portion 44. The plurality of fit-in recesses 50g are formed at positions respectively facing the plurality of fit-in protrusions 44p. A position where each fit-in protrusion 44p is fit into the corresponding fit-in recess 50g is a position distant from the spring fulcrum 52a of the spring connecting portion 53 toward a radially outer side. That is, concerning all the spring connecting portions 53, the spring connecting portions 53 and the positions where the fit-in protrusions 44p are fit into the fit-in recesses 50g are located at the same positions in a circumferential direction of a circle centered on the center axis X of the tube portion 42.

### <Effects, etc.>

According to the connector 30 configured as described above, the spring connecting portion 53 is resiliently pressed against the mating connection conductor 50 with a contact pressure having a force component along the axial direction of the tube portion 42. To generate the contact pressure having the force component along the axial direction of the tube portion 42 by the spring connecting portion 53, the spring connecting portion 53 may extend in the direction intersecting the axial direction of the tube portion 42. Thus, as compared to a configuration in which a contact pressure is generated in a direction perpendicular to the axial direction of the tube portion 42, the size of the spring connecting portion 53 can be reduced in the direction along the axial direction of the tube portion 42. In this way, the outer conductor 40 of the connector 30 can be connected to the mating connection conductor 50 by a compact configuration, and the entire device 10 can be reduced in size. Particularly, the size of the device 10 in the front-rear direction can be reduced. Further, since the mating connection conductor 50 and the outer conductor 40 are electrically connected via the spring connecting portions 53, even if a positional relationship of the mating connection conductor 50 and the outer conductor 40 changes due to an assembly error, thermal expansion or contraction or the like, the spring connecting portions 53 are held satisfactorily pressed against the projecting portion 44. The connection reliability of the mating connection conductor 50 and the outer conductor 40 is improved.

Further, if the mating connection conductor 50 is a shield conductor, a projecting amount of the outer conductor 40 from the mating connection conductor 50 serving as a shield conductor can be reduced. In this way, a projecting amount of the outer conductor 40 from the device 10 can be reduced.

Further, if the mating connection conductor 50 includes the spring connecting portions 53, the projecting portion 44 of the outer conductor 40 may not be provided with spring connecting portions. In this way, limitations in manufacturing the outer conductor 40 are reduced and the outer conductor 40 can be easily manufactured.

For example, if an outer conductor is formed by press-working a metal plate or by cutting a metal block, the outer conductor can be formed with spring connecting portions. However, if the outer conductor is formed by press-working the metal plate, there is a possibility that slits are formed in the outer conductor by joints and electromagnetic shielding performance is affected. Further, if the outer conductor is formed by cutting, the manufacturing cost of the outer conductor is increased. If the outer conductor is manufactured by deep drawing, no slit is formed, good electromagnetic shielding performance can be obtained, and cost is lower than that for the outer conductor formed by cutting. If the outer conductor is manufactured by deep drawing, the projecting portion may be possibly thinned to an extent not suitable to form the spring connecting portions. However, since the mating connection conductor 50 is formed with the spring connecting portions 53 in this embodiment, there is no problem even if the projecting portion 44 is thinned. Therefore, the electromagnetic shielding performance of the outer conductor 40 can be improved and cost can be reduced by reducing manufacturing limitations of the outer conductor 40.

Further, since the projecting portion 44 and the mating connection conductor 50 are fixed at positions closer to the spring fulcrums 53a than to the spring connecting portions 53, a fixed positional relationship of the projecting portion 44 and the mating connection conductor 50 can be maintained. In this way, the contact pressures by the spring connecting portions 53 are easily ensured.

Further, since the projecting portion 44 and the mating connection conductor 50 are fixed to each other by being pressed while being overlapped with each other, the projecting portion 44 and the mating connection conductor 50 can be easily fixed as compared to the case where those are welded. By directly fixing the projecting portion 44 and the mating connection conductor 50, the spring fulcrums 53a of the spring connecting portions 53 are more reliably held at the fixed positions with respect to the projecting portion 44. For example, even if the second case 14 is deformed due to thermal expansion or contraction and the holding positions of the tube portion 42 and the projecting portion 44 by the second case 14 are displaced, the spring fulcrums 53a of the spring connecting portions 53 are more reliably held at the fixed positions with respect to the projecting portion 44 by the direct fixing position of the projecting portion 44 and the mating connection conductor 50. Thus, the contact pressures by the spring connecting portions 53 are stabilized.

Further, since the connector 30 includes the plurality of spring connecting portions 53, the connection reliability of the outer conductor 40 and the mating connection conductor 50 can be improved.

Further, by distributing the plurality of spring connecting portions 53 around the tube portion 42, a contact state of the outer conductor 40 and the mating connection conductor 50 via the spring connecting portions 53 of either one of these is easily maintained even if the tube portion 42 is inclined. In this way, the connection reliability of the outer conductor 40 and the mating connection conductor 50 can be improved.

Further, since the plurality of spring connecting portions 53 are distributed at equal intervals around the tube portion 42, the plurality of spring connecting portions 53 easily contact the projecting portion 44 in a uniform state (e.g. positional relationship, force). In the way, connection stability is improved.

Further, if the projecting portion 44 and the mating connection conductor 50 are fixed at the plurality of positions, the projecting portion 44 and the mating connection conductor 50 are more easily kept in the fixed positional relationship. In this way, the plurality of spring connecting portions 53 are more easily held in contact with the projecting portion 44.

Further, if the projecting portion 44 and the mating connection conductor 50 are fixed at the plurality of positions distributed around the tube portion 42, the plurality of spring connecting portions 53 are more easily held in contact with the projecting portion 44.

Further, if the projecting portion 44 and the mating connection conductor 50 are fixed at the plurality of positions uniformly distributed around the tube portion 42, the projecting portion 44 and the mating connection conductor 50 are easily kept in the fixed positional relationship with each other uniformly around the tube portion 42. In this way, the spring connecting portions 53 are easily held in contact with the projecting portion 44.

Further, the plurality of spring connecting portions 53 and the plurality of fixing positions of the projecting portion 44 and the mating connection conductor 50 have the same positional relationship and are in a one-to-one correspondence. Thus, contact pressures by the respective spring connecting portions 53 are easily made equal and connection reliability is improved by a plurality of contact positions.

### Modifications

The example in which the spring connecting portions 53 are provided in the mating connection conductor 50 is described in the above embodiment. As in a modification shown in FIG. 7, an outer conductor 140 corresponding to the outer conductor 40 may include a projecting portion 144 corresponding to the projecting portion 44, and this projecting portion 144 may include spring connecting portions 146. The spring connecting portion 146 is, for example, formed by cutting a part of the projecting portion 144 into a U shape and bending a part of the cut section to project toward a mating connection conductor 150 corresponding to the mating connection conductor 50. The spring connecting portion 146 may be connected to a body part of the projecting portion 144 at any position with respect to the projecting portion 144. In FIG. 7, the spring connecting portion 146 is connected to the body part of the projecting portion 144 on an outer peripheral side of the projecting portion 144.

In the mating connection conductor 150, spring connecting portions 53 are not formed in a part around an opening 54, out of a bottom portion 152 corresponding to the bottom portion 52, and this part is in the form of a flat plate.

According to this modification, the spring connecting portions 146 are pressed against the outward facing surface of the bottom portion 152. The spring connecting portions 146 intersect the axial direction of the tube portion 42 and, particularly, are along an extension direction of the projecting portion 144. Thus, the spring connecting portion 146 is resiliently pressed against the mating connection conductor 150 with a contact pressure having a force component along the axial direction of the tube portion 42.

Also by this modification, the size of the spring connecting portion 146 can be reduced in a direction along the axial direction of the tube portion 42. Thus, functions and effects similar to those of the above embodiment can be obtained except those obtained by providing the spring connecting portions 53 in the mating connection conductor 50.

In the above embodiment, a connection target of the connector 30 is assumed to be a coaxial cable and an example in which a connector includes one inner conductor is described. For example, such as when a connection mode of the connector is a cable including two core wires, the connector is assumed to include a plurality of inner conductors.

The above connector 30 may be applied to connect an electrical component not based on the device 10 and a cable.

In the above embodiment, the plurality of spring connecting portions 53 and the fixing positions of the bottom portion 52 of the mating connection conductor 50 and the projecting portion 44 are at the same positions in the circumferential direction around the tube portion 42. However, the fixing positions may be provided to correspond to some of the plurality of spring connecting portions in the circumferential direction around the tube portion. Further, the spring connecting portions may be provided at some of the plurality of fixing positions in the circumferential direction around the tube portion.

Further, the plurality of spring connecting portions and the plurality of fixing positions may be shifted around the tube portion. For example, the spring connecting portions may be provided at intervals of 90° around the tube portion, and the fixing positions may be provided at intervals of 90° at positions shifted from the spring connecting portions by 45°.

Note that the respective configurations described in the above embodiment and the respective modifications can be appropriately combined as long as these do not contradict each other.

### LIST OF REFERENCE NUMERALS

10 device
12 case
13 first case
14 second case
15 bottom portion
15p fixing protrusion
16 holding tube portion
17 holding/partitioning portion
17h holding hole
18a locking protrusion
20 electrical component
21 circuit board
22 imaging element
24 board-side connector
25 board-side inner conductor
26 board-side insulator
27 board-side outer conductor
30 connector
32 terminal module
34 inner conductor
36 insulator
36h through hole
40, 140 outer conductor
42 tube portion
44, 144 projecting portion
44p fit-in protrusion
45 recess
50, 150 mating connection conductor (shield conductor)
50g fit-in recess
52, 152 bottom portion
52h hole
53, 146 spring connecting portion
53S slit
53a spring fulcrum
53b free end
53c spring contact point
54 opening
80 press mold
82 mold
90 relay connector
91 movable-side inner conductor
92 movable-side insulator
93 movable-side outer conductor

1. A connector, comprising:
a terminal module including an inner conductor, an insulator surrounding the inner conductor and an outer conductor having a tube portion surrounding the insulator and a projecting portion projecting outwardly of the tube portion; and
a mating connection conductor,
at least one of the mating connection conductor and the projecting portion including a spring connecting portion to be resiliently pressed against the other of the mating connection conductor and the projecting portion with a contact pressure having a force component along an axial direction of the tube portion.

2. The connector of claim 1, wherein the mating connection conductor is a shield conductor.

3. The connector of claim 1, wherein the mating connection conductor includes the spring connecting portion.

4. The connector of claim 1, wherein:
the spring connecting portion includes a spring fulcrum and a spring contact point, and
the projecting portion and the mating connection conductor are fixed at a position closer to the spring fulcrum than to the spring contact point.

5. The connector of claim 4, wherein the projecting portion and the mating connection conductor are fixed to each other by being pressed while being overlapped with each other.

6. The connector of claim 1, comprising a plurality of the spring connecting portions.

7. The connector of claim 6, wherein the plurality of spring connecting portions are distributed around the tube portion.

8. The connector of claim 7, wherein the plurality of spring connecting portions are distributed at equal intervals around the tube portion.

9. The connector of claim 6, wherein the projecting portion and the mating connection conductor are fixed at a plurality of positions.

10. The connector of claim 9, wherein the projecting portion and the mating connection conductor are fixed at the plurality of positions distributed around the tube portion.

11. The connector of claim 10, wherein the projecting portion and the mating connection conductor are fixed at the plurality of positions uniformly distributed around the tube portion.

12. The connector of claim 9, wherein the plurality of spring connecting portions and the plurality of fixing positions of the projecting portion and the mating connection conductor have the same positional relationship and are in a one-to-one correspondence.
